(19) United States
(12) Patent Application Publication
(10) Pub. No.: US 2026/0289818 A1
(43) Pub. Date: Sep. 24, 2026

(54) AUTONOMOUS DRIVING DEVICE FOR CALIBRATING SENSOR PARAMETER AND CALIBRATION METHOD THEREOF

(71) Applicant: Samsung Electronics Co., Ltd., Suwon=si (KR)

(72) Inventors: Taeyoon LEE, Suwon-si (KR); Boseok Moon, Suwon-si (KR)

(73) Assignee: Samsung Electronics Co., Ltd., Suwon-si (KR)

(21) Appl. No.: 19/467,364

(22) Filed: Feb. 2, 2026

Related U.S. Application Data
(63) Continuation of application No. PCT/KR2024/016788, filed on Oct. 30, 2024.

(30) Foreign Application Priority Data
Nov. 16, 2023 (KR) 10-2023-0159302

(51) Int. Cl. G06T 7/80; G05D 1/24; G05D 1/86; G05D 109/10; G05D 111/10; G05D 111/30; H04W 4/46

(52) U.S. Cl. CPC G06T 7/80; G05D 1/24; G05D 1/86; H04W 4/46; G05D 2109/10; G05D 2111/10; G05D 2111/30; G06T 2207/30252

(57) ABSTRACT

An autonomous driving apparatus includes a sensor for performing sensing based on at least one sensor parameter. The apparatus stories first observation information obtained by identifying objects present in a space in which the autonomous driving apparatus is positioned in the memory based on a sensing value of the sensor. The apparatus obtains second observation information obtained from at least one external autonomous driving apparatus and driving history information of the at least one external autonomous driving apparatus from among objects present in the space. The apparatus adds, based on driving history information of the autonomous driving apparatus and the driving history information of the at least one external autonomous driving apparatus, weight values to each of the first observation information and the second observation information stored in the memory, and calibrates the at least one sensor parameter by comparing first and second observation information added with the weight values.

### CROSS-REFERENCE TO RELATED APPLICATIONS

This application is a continuation of International Application No. PCT/KR2024/016788, filed on Oct. 30, 2024, which claims priority to Korean Patent Application No. 10-2023-0159302, filed on Nov. 16, 2023, in the Korean Intellectual Property Office, the disclosures of which are incorporated by reference herein in their entireties.

### BACKGROUND

### 1. Field

The disclosure relates to an autonomous driving apparatus for calibrating sensor parameter and a calibration method thereof, and more particularly to an autonomous driving apparatus for calibrating sensor parameter by obtaining various observation information from the outside and a calibration method thereof.

### 2. Description of Related Art

Recently, autonomous driving apparatuses are being used in various environments. An autonomous driving apparatus may mean an apparatus that a person gets in directly and drives, or is capable of autonomous driving by identifying a path without having to operate remotely. In an autonomous driving apparatus, a technology for generating a map of a space in which the apparatus itself is positioned through sensors such as LiDAR and camera, and identifying the position of the autonomous driving apparatus on the map may be used.

In order for accurate mapping and localization to be carried out, sensor parameters have to be appropriately set. A sensor parameter may be a variety of variables that affect a sensing operation of a sensor installed in the apparatus. However, when using the autonomous driving apparatus, there may be cases in which the autonomous driving apparatus impacts with a surrounding obstacle, or other external force being applied. In this case, there may be problems such as a position and direction of a sensor of the autonomous driving apparatus being misaligned, and localization and mapping of the autonomous driving apparatus being inaccurate.

At this time, the sensor parameter has to be suitably calibrated, and in conventional cases, a method for calibrating the sensor parameter using surrounding objects as landmarks or calibrating only a relationship with a counterpart autonomous driving apparatus has been utilized. However, when using surrounding objects as landmarks, there have been many inconveniences to users operating the autonomous driving apparatus such as requiring many landmarks for calibration of an accurate sensor parameter, or having to capture landmarks from various angles. In addition, the method for calibrating the sensor parameter using only the relationship with the counterpart autonomous driving apparatus has a problem that if sensor parameters of two or more autonomous driving apparatuses are all not accurate, accurate calibration of the sensor parameters may be difficult even if the relationships with the counterpart autonomous driving apparatuses are used, and from the perspective of a typical user of an autonomous driving apparatus, difficulty arising may be inevitable. Accordingly, the calibration for the sensor parameter of the autonomous driving apparatus may be performed automatically, and even if a problem arose with the sensor parameters of a portion of the autonomous driving apparatuses from among a plurality of autonomous driving apparatuses, there has been a growing need for technology with which the sensor parameters can be calibrated accurately using the plurality of autonomous driving apparatuses.

### SUMMARY

According to an aspect of the disclosure, there is provided an autonomous driving apparatus, including: a communication part; a sensor for performing sensing based on at least one sensor parameter; memory storing instructions; and at least one processor, wherein the instructions, when executed by the at least one processor, cause the autonomous driving apparatus to: store, in the memory, first observation information obtained by identifying objects present in a space in which the autonomous driving apparatus is positioned in the memory based on a sensing value of the sensor; obtain, through the communication part, second observation information obtained from at least one external autonomous driving apparatus and driving history information of the at least one external autonomous driving apparatus from among objects present in the space, and store the second observation information and the driving history information in the memory; add, based on driving history information of the autonomous driving apparatus and the driving history information of the at least one external autonomous driving apparatus, weight values to each of the first observation information and the second observation information stored in the memory; and calibrate the at least one sensor parameter by comparing first and second observation information added with the weight values.

The first observation information may include position information of the autonomous driving apparatus estimated by the autonomous driving apparatus, wherein the second observation information may include the position information of the autonomous driving apparatus estimated by the at least one external autonomous driving apparatus, and wherein the instructions, when executed by the at least one processor, may cause the autonomous driving apparatus to: add, based on the driving history information of the autonomous driving apparatus and the driving history information of the at least one external autonomous driving apparatus, the weight values to each of the position information of the autonomous driving apparatus estimated by the autonomous driving apparatus and the position information of the autonomous driving apparatus estimated by the at least one external autonomous driving apparatus; and compare the position information added with the weight values and calibrate the at least one sensor parameter to compensate a difference thereof.

The driving history information of the at least one external autonomous driving apparatus may include at least one from among a number of times the at least one external autonomous driving apparatus collided with an obstacle present in the space, an intensity with which the at least one external autonomous driving apparatus collided with the obstacle present in the space, a driving time of the at least one external autonomous driving apparatus in the space, or a time at which a sensor parameter of a sensor mounted to the at least one external autonomous driving apparatus is most recently calibrated.

The instructions, when executed by the at least one processor, may cause the autonomous driving apparatus to: compare a number of collisions generated by each of the autonomous driving apparatus and the at least one external autonomous driving apparatus while driving in the space with one another; and add the weight values consecutively larger in an order from the autonomous driving apparatus with a large number of collisions to the autonomous driving apparatus with a small number of collisions.

The instructions, when executed by the at least one processor, may cause the autonomous driving apparatus to: compare collision intensities of each of the autonomous driving apparatus and the at least one external autonomous driving apparatus that collided while driving in the space; and add the weight values consecutively larger in an order from the autonomous driving apparatus with a large collision intensity to the autonomous driving apparatus with a small collision intensity.

The instructions, when executed by the at least one processor, may cause the autonomous driving apparatus to: compare driving times of each of the autonomous driving apparatus and the at least one external autonomous driving apparatus in the space; and add the weight values consecutively larger in an order from the autonomous driving apparatus with a long driving time to the autonomous driving apparatus with a short driving time.

The instructions, when executed by the at least one processor, may cause the autonomous driving apparatus to: identify a difference between a latest calibration time and a current time of each of the autonomous driving apparatus and the at least one external autonomous driving apparatus; and add the weight values consecutively larger in an order from the autonomous driving apparatus with a greatest difference to the autonomous driving apparatus with a smallest difference.

The instructions, when executed by the at least one processor, may cause the autonomous driving apparatus to: identify a difference between an observation information collection time and a current time of each of the autonomous driving apparatus and the at least one external autonomous driving apparatus; and add the weight values consecutively larger in an order from observation information with a greatest difference to observation information with a smallest difference.

According to an aspect of the disclosure, there is provided a calibration method of an autonomous driving apparatus, the calibration method including: storing first observation information obtained by identifying objects present in a space in which the autonomous driving apparatus is positioned based on a sensing value of a sensor; obtaining second observation information obtained from at least one external autonomous driving apparatus and driving history information of the at least one external autonomous driving apparatus from among objects present in the space, and storing the second observation information and the driving history information; and adding, based on driving history information of the autonomous driving apparatus the and the driving history information of the at least one external autonomous driving apparatus, weight values to each of the stored first observation information and the second observation information; and calibrating at least one sensor parameter of the sensor by comparing first and second observation information added with the weight values.

The first observation information may include position information of the autonomous driving apparatus estimated by the autonomous driving apparatus, wherein the second observation information may include the position information of the autonomous driving apparatus estimated by the at least one external autonomous driving apparatus, and wherein the calibrating the at least one sensor parameter of the sensor may include: adding, based on the driving history information of the autonomous driving apparatus and the driving history information of the at least one external autonomous driving apparatus, the weight values to each of the position information of the autonomous driving apparatus estimated by the autonomous driving apparatus and the position information of the autonomous driving apparatus estimated by the at least one external autonomous driving apparatus; and comparing the position information added with the weight values and calibrating the at least one sensor parameter to compensate a difference thereof.

The calibrating the at least one sensor parameter of the sensor may include: comparing a number of collisions generated by each of the autonomous driving apparatus and the at least one external autonomous driving apparatus while driving in the space with one another; and adding the weight values consecutively larger in an order from the autonomous driving apparatus with a large number of collisions to the autonomous driving apparatus with a small number of collisions.

The calibrating the at least one sensor parameter of the sensor may include: comparing collision intensities of each of the autonomous driving apparatus and the at least one external autonomous driving apparatus that collided while driving in the space; and adding the weight values consecutively larger in an order from the autonomous driving apparatus with a large collision intensity to the autonomous driving apparatus with a small collision intensity.

The calibrating the at least one sensor parameter of the sensor may include: comparing driving times of each of the autonomous driving apparatus and the at least one external autonomous driving apparatus in the space; and adding the weight values consecutively larger in an order from the autonomous driving apparatus with a long driving time to the autonomous driving apparatus with a short driving time.

The calibrating the at least one sensor parameter of the sensor may include: identifying a difference between an observation information collection time and a current time of each of the autonomous driving apparatus and the at least one external autonomous driving apparatus, and adding the weight values consecutively larger in an order from observation information with a greatest difference to observation information with a smallest difference.

According to an aspect of the disclosure, there is provided a non-transitory computer-readable recording medium storing computer instructions for an autonomous driving apparatus to perform an operation when executed by a processor of the autonomous driving apparatus, the operation including: storing first observation information obtained by identifying objects present in a space in which the autonomous driving apparatus is positioned based on a sensing value of a sensor; receiving and storing second observation information from at least one external autonomous driving apparatus and driving history information of the at least one external autonomous driving apparatus from among objects present in the space; and adding, based on driving history information of the autonomous driving apparatus and the driving history information of the at least one external autonomous driving apparatus, weight values to each of the stored first observation information and the second observation information, and calibrating at least one sensor parameter of the sensor.

### BRIEF DESCRIPTION OF THE DRAWINGS

The above and other aspects and features of embodiments of the disclosure will be more apparent from the following description taken in conjunction with the accompanying drawings, in which:

FIG. 1 is a diagram schematically illustrating an operation of an autonomous driving apparatus according to one or more embodiments of the disclosure;

FIG. 2 is a block diagram illustrating a configuration of an autonomous driving apparatus according to one or more embodiments of the disclosure;

FIG. 3 is a diagram illustrating an operation of an autonomous driving apparatus according to one or more embodiments of the disclosure;

FIG. 4 is a diagram illustrating a position information generating method of an autonomous driving apparatus according to one or more embodiments of the disclosure;

FIG. 5 is a diagram illustrating a sensor parameter calibrating method of an autonomous driving apparatus according to one or more embodiments of the disclosure;

FIG. 6 is a diagram illustrating an operation of an autonomous driving apparatus according to one or more embodiments of the disclosure;

FIG. 7 is a diagram illustrating a weight value adding method of an autonomous driving apparatus according to one or more embodiments of the disclosure; and

FIG. 8 is a flowchart illustrating a calibration method of a sensor parameter of an autonomous driving apparatus according to one or more embodiments of the disclosure.

### DETAILED DESCRIPTION

The disclosure will be described in detail below with reference to the accompanying drawings.

Terms used in the embodiments of the disclosure are general terms selected that are currently widely used considering their function herein. However, the terms may change depending on intention, legal or technical interpretation, emergence of new technologies, and the like of those skilled in the related art. Further, in certain cases, there may be terms arbitrarily selected, and in this case, the meaning of the term will be disclosed in greater detail in the corresponding description. Accordingly, the terms used herein are not to be understood simply as its designation but based on the meaning of the term and the overall context of the disclosure.

In the disclosure, expressions such as “have”, “may have”, “include”, and “may include” are used to designate a presence of a corresponding characteristic (e.g., elements such as numerical value, function, operation, or component), and not to preclude a presence or a possibility of additional characteristics.

The expression at least one of A and/or B is to be understood as indicating any one of “A” or “B” or “A and B”.

Expressions such as “1st”, “2nd”, “first”, or “second” used in the disclosure may limit various elements regardless of order and/or importance, and may be used merely to distinguish one element from another element and not limit the relevant element.

When a certain element (e.g., first element) is indicated as being “(operatively or communicatively) coupled with/to” or “connected to” another element (e.g., second element), it may be understood as the certain element being directly coupled with/to the another element or as being coupled through other element (e.g., third element).

A singular expression includes a plural expression, unless otherwise specified. It is to be understood that the terms such as “form” or “include” are used herein to designate a presence of a characteristic, number, step, operation, element, component, or a combination thereof, and not to preclude a presence or a possibility of adding one or more of other characteristics, numbers, steps, operations, elements, components or a combination thereof.

The term “module” or “part” used herein perform at least one function or operation, and may be implemented with hardware or software, or implemented with a combination of hardware and software. In addition, a plurality of “modules” or a plurality of “parts”, except for a “module” or a “part” which needs to be implemented with a specific hardware, may be integrated in at least one module and implemented as at least one processor (not shown).

In the disclosure, the term “user” may refer to a person using an electronic device or an apparatus using the electronic apparatus (e.g., artificial intelligence electronic apparatus).

An embodiment of the disclosure will be described in greater detail below with reference to the accompanied drawings.

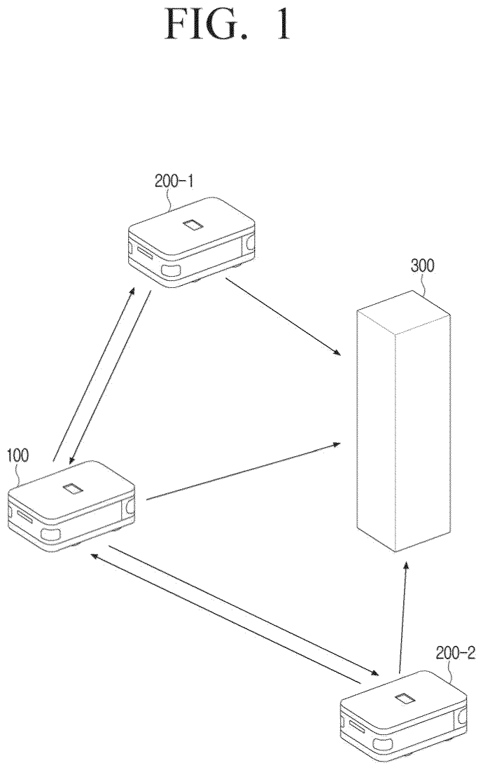

FIG. 1 is a diagram schematically illustrating an operation of an autonomous driving apparatus according to one or more embodiments of the disclosure.

An autonomous driving apparatus 100 may be an apparatus that is capable of driving autonomously without human interference. The autonomous driving apparatus 100 may be implemented as apparatuses of various types such as, for example, and without limitation, an autonomous driving robot, an autonomous driving vehicle, an autonomous driving drone, a cleaner, a robot for serving, a mobile-type projector, a mobile-type speaker, and the like.

Referring to FIG. 1, the autonomous driving apparatus 100 may observe (or identify) various external objects that are present in a space in which the autonomous driving apparatus 100 is positioned. Specifically, the autonomous driving apparatus 100 may observe external autonomous driving apparatuses 200-1 and 200-2 that are present in the same space, and observe structures such as, for example, and without limitation walls, doors, ceilings, pillars, and the like that constitute the space, and various objects that are present in the space. The structures or objects that are present at fixed positions within the space may be used as landmarks 300.

In the disclosure, a space may be a surrounding environment in which the autonomous driving apparatus 100 is positioned. If the autonomous driving apparatus is a vehicle or a drone, various external environments such as roads, sky, and the like may be included in the space, and if implemented in a form of a home appliance such as a cleaner or a mobile-type projector, a mobile-type speaker, and the like, a typical home environment, an indoor environment, or the like may be included in the space. A landmarks 300 may be an identifiable point or object with which the autonomous driving apparatus 100 expresses the surrounding environment, and assists in the autonomous driving apparatus estimating its position. For example, the landmarks 300 may be various objects with characteristics that are distinguishable from the surrounding environment such as walls, doors, or pillars that constitute the space, objects that are fixed to specific positions in the space, or the like.

The autonomous driving apparatus 100 may drive avoiding collisions with other external objects in the space based on a sensing value of a sensor. The autonomous driving apparatus 100 may generate, based on the sensing value of the sensor, a map of an internal structure of the space and then, determine a driving route based on the map, and drive along the driving route. In order to avoid collision with the external objects, and suitably set a driving route to a target point, the autonomous driving apparatus 100 may have to accurately generate a map of the space in which it is positioned, and accurately identify its position information. The sensor parameter may be classified as an extrinsic parameter and an intrinsic parameter of the sensor. In the extrinsic parameter, a position, direction, and the like of the sensor may be included, and in the intrinsic parameter, a FOV of a LiDAR sensor, a focal range and a principal point of a camera, and the like may be included.

The position, direction, principal point, focal range, and the like of the sensor of the autonomous driving apparatus 100 may be changed due to the autonomous driving apparatus colliding with an external object, external force applied by a user, various forces such as inertia and gravity generated when driving at high-speed or suddenly stopping, or degradation of components. In this case, the position, direction, and the like of the sensor may change, but the sensor parameter may maintain a previous value unless the user changes sensor parameter values directly by an amount of change in position and direction of the sensor. In this case, because the autonomous driving apparatus 100 can only perform inaccurate mapping and localization, calibration of the sensor parameter is needed.

The autonomous driving apparatus of the related art performed calibration through methods such as having the user calibrate the sensor parameter directly or comparing sensing data of a plurality of sensors and calibrating the sensor parameter using the plurality of sensors mounted to one autonomous driving apparatus.

The autonomous driving apparatus 100 according to one or more embodiments of the disclosure may collectively consider not only observation information observed by the autonomous driving apparatus 100 itself of its surroundings, but also observation information observed by the external autonomous driving apparatuses 200-1 and 200-2 of their surroundings. Accordingly, the autonomous driving apparatus may automatically calibrate and provide the sensor parameter of its own sensor. Observation information may be information about a detection result of having sensed the surroundings using at least one sensor. The observation information may be otherwise variously referred to as sensing information, detection information, and the like, but will be described as observation information in the disclosure. In addition, for convenience of description, observation information observed from the autonomous driving apparatus itself may be referred to as first observation information, and observation information observed from an external autonomous driving apparatus may be referred to as second observation information.

Specifically, the autonomous driving apparatus 100 may obtain second observation information from at least one of the external autonomous driving apparatuses 200-1 and 200-2, and after adding weight values to the first observation information observed by itself and to the second observation information, automatically calibrate the sensor parameter of the autonomous driving apparatus based on information added with the weight values. Based on the above, even if the user does not periodically examine whether or not there is a problem with the sensor of the autonomous driving apparatus 100, the autonomous driving apparatus 100 may perform accurate mapping and localization and may perform an effective operation through the above.

In FIG. 1, the external autonomous driving apparatuses 200-1 and 200-2 have been shown as autonomous driving apparatuses of the same kind as with the autonomous driving apparatus 100, but the above is merely one example, and even when the above are autonomous driving apparatuses of different kinds such as the external autonomous driving apparatuses 200-1 and 200-2 being autonomous driving vehicles and the autonomous driving apparatus 100 being an autonomous driving robot, observation information may be transmitted and received with one another and the sensor parameter may be automatically calibrated.

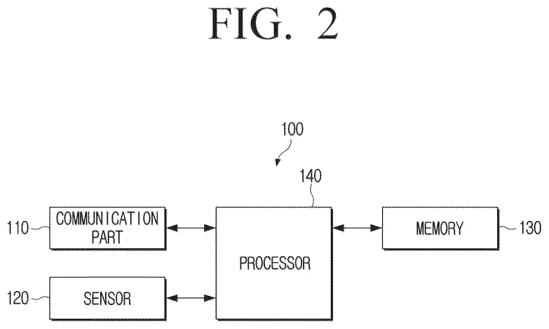

FIG. 2 is a block diagram illustrating a configuration of an autonomous driving apparatus according to one or more embodiments of the disclosure.

Referring to FIG. 2, the autonomous driving apparatus 100 may include a communication part 110, a sensor 120, memory 130, and a processor 140.

The communication part 110 may be a configuration for performing communication with various external apparatuses. The communication part 110 may receive (or obtain) observation information, in other words, second observation information from at least one of the external autonomous driving apparatuses. In addition, the communication part 110 may transmit, according to control of the processor 140, observation information, in other words, first observation information of the autonomous driving apparatus 100 to at least one external autonomous driving apparatus.

The communication interface 110 be connected with at least one external autonomous driving apparatus through communication methods such as, for example, and without limitation, Bluetooth, an AP based Wi-Fi (wireless LAN network), Zigbee, a wired/wireless local area network (LAN), a wide area network (WAN), Ethernet, IEEE 1394, a high-definition multimedia interface (HDMI), a universal serial bus (USB), a mobile high-definition link (MHL), Audio Engineering Society/European Broadcasting Union (AES/EBU), Optical, Coaxial, or the like.

The communication part 110 may transmit and receive driving history information in addition to the observation information. The driving history information may include various information associated with driving of the autonomous driving apparatus.

The sensor 120 may be a configuration for performing sensing based on at least one sensor parameter with respect to the space in which the autonomous driving apparatus 100 is positioned. The sensor 120 may include all various sensors with which the autonomous driving apparatus 100 can generate a map of the space such as a camera, an IMU sensor, an encoder, and a LiDAR, or with which a position of the autonomous driving apparatus 100 may be identified.

In FIG. 2, one sensor 120 has been shown, but a plurality of sensors of various different kinds may be used according to types, sizes, forms, use environments, and the like of the autonomous driving apparatus 100.

The memory 130 may be a configuration for storing instructions, an operating system and application programs, or associated data for controlling the overall operation of the autonomous driving apparatus 100. The memory 130 may store observation information obtained based on the sensing value and sensor parameter of the sensor 120 and observation information obtained through the communication part 110 from the external autonomous driving apparatus, and driving history information of the external autonomous driving apparatus.

Here, the observation information may include position information that is obtainable by performing computation using the sensor parameter with the sensing value of the sensor 120. The driving history information of the external autonomous driving apparatus may include information such as a number of collisions by the external autonomous driving apparatus with an obstacle, and driving time in the space. The observation information and the driving history information will be described in detail in the following description.

The memory 130 according to one or more embodiments of the disclosure may be implemented as an internal memory such as a ROM (e.g., electrically erasable programmable read-only memory (EEPROM)), a RAM, and the like included in the processor 140, or implemented as memory separate from the processor 140. In this case, the memory 130 may be implemented in a form of memory embedded in the autonomous driving apparatus 100 according to data storage use, or implemented in a form of a memory attachable to or detachable from the autonomous driving apparatus 100. For example, data for the driving of the autonomous driving apparatus 100 may be stored in the memory embedded in the autonomous driving apparatus 100, and data for an expansion function of the autonomous driving apparatus 100 may be stored in the memory attachable to or detachable from the autonomous driving apparatus 100.

Meanwhile, the memory embedded in the autonomous driving apparatus 100 may be implemented as at least one of a volatile memory (e.g., dynamic RAM (DRAM), static RAM (SRAM), or synchronous dynamic RAM (SDRAM)), or a non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash), hard disk drive (HDD) or solid state drive (SSD)), and the memory attachable to or detachable from the autonomous driving apparatus 100 may be implemented in a form such as, for example, and without limitation, a memory card (e.g., compact flash (CF), secure digital (SD), micro secure digital (micro-SD), mini secure digital (mini-SD), extreme digital (xD), multi-media card (MMC), etc.), an external memory (e.g., USB memory) connectable to a USB port, or the like.

The processor 140 may control the overall operation of the autonomous driving apparatus 100. Specifically, the processor 140 may be connected with the communication part 110, the sensor 120, and the memory 130, and perform various operations by executing at least one instruction stored in the memory 130.

The processor 140 may be implemented as a digital signal processor (DSP) that processes a digital signal, or a microprocessor. However, the embodiment is not limited thereto, and may include one or more from among a central processing unit (CPU), a micro controller unit (MCU), a micro processing unit (MPU), a controller, an application processor (AP), a communication processor (CP), an ARM processor, or an artificial intelligence (AI) processor, or may be defined by the relevant term. In addition, the processor 140 may be implemented as a System on Chip (SoC) or a large scale integration (LSI) in which a processing algorithm is embedded, and may be implemented in a form of a field programmable gate array (FPGA). The processor 140 may perform various functions by executing computer executable instructions stored in the memory 130.

If a method according to various embodiments of the disclosure include a plurality of operations, the plurality of operations may be performed by one processor or performed by a plurality of processors. The processor 140 may be implemented as a single core processor that includes one core, or implemented as one or more multicore processors that include a plurality of cores (e.g., homogeneous multicore or heterogeneous multicore).

The processor 140 may obtain observation information by observing (or identifying) objects that are present in the space in which the autonomous driving apparatus 100 is positioned based on the sensing value of the sensor 120. Here, the objects present in the space may include an external autonomous driving apparatus, objects (e.g., walls, furniture, home appliances, etc.) fixed at specific positions within the space, objects that change in position within the space (e.g., humans or animals), and the like.

In an example, if the sensor 120 includes a camera, the processor 140 may capture objects through the camera, and obtain observation information that include position information of objects through an image of the captured object. At this time, the position information of the object may be obtained through computation based on an extrinsic parameter and an intrinsic parameter of the camera.

The extrinsic parameter of the camera may include a position at which the camera is installed on the autonomous driving apparatus, a direction to which the camera is installed, and the like, and the processor 140 may perform a computation for converting from a world coordinate system to a camera coordinate system and a computation for converting from the camera coordinate system to the world coordinate system based on the extrinsic parameter of the camera. Here, the world coordinate system may be a coordinate system that is referenced when representing a position of an object in general, and may mean a coordinate system that calculates coordinate values of a specific position based on an X-axis, a Y-axis, and a Z-axis using a random point in space as an original point. In addition, the camera coordinate system may be a coordinate system that calculates coordinate values based on the camera, and may mean a coordinate system that calculates coordinate values of a specific position based on the X-axis, the Y-axis, and the Z-axis using the point at which the camera is positioned as the original point. If the processor 140 accurately identifies an extrinsic parameter value of the camera, coordinate values in the camera coordinate system may be accurately changed to coordinate values in the world coordinate system, and the coordinate values in the world coordinate system may also be accurately changed to the coordinate values in the camera coordinate system.

The intrinsic parameter of the camera may include the principal point, the focal range, and the like of the camera, and the processor 140 may perform a computation for converting from an image coordinate system to a camera coordinate system and a computation for converting the camera coordinate system to the image coordinate system. Here, the image coordinate system may mean a coordinate system that calculates the coordinate values of a specific position based on the X-axis and the Y-axis using a specific point in a 2D image captured from a camera as the original point. If the processor 140 accurately identifies the intrinsic parameter of the camera, coordinate values in the image coordinate system may be accurately converted to coordinate values in the camera coordinate system, and the coordinate values in the camera coordinate system may also be accurately converted to the coordinate values in the image coordinate system.

Accordingly, the processor 140 may obtain coordinate values (a, b) in the image coordinate system of a specific object present in an image captured through the camera and then, convert (a, b) to coordinate values (a′, b′, c′) in the camera coordinate system through computation based on the intrinsic parameter of the camera. Then, the processor 140 may convert (a′, b′, c′) to coordinate values (a″, b″, c″) in the world coordinate system through computation based on the extrinsic parameter of the camera. The processor 140 may obtain observation information about the specific object by obtaining the coordinate values (a″, b″, c″) in the world coordinate system of the specific object.

In the description above, only the method for obtaining the observation information about the object present in the space through the camera has been described, but this is merely one example, and in addition to the above, observation information may be obtained using various sensors. For example, if the sensor 120 includes a LiDAR sensor, observation information of an external object may be obtained based on the extrinsic parameter such as a position at which the LiDAR sensor is mounted to the apparatus and a direction to which the LiDAR sensor is mounted and the intrinsic parameter such as a field of view (FOV) of the LiDAR sensor, a emission angle of a laser, and a reception intensity of the laser.

In the description above, only the method for obtaining position information with respect to the external object present in the space has been described, but the processor 140 may also estimate position information of the autonomous driving apparatus 100 based on the external object with the already known position information. For example, if coordinate values of an external object is already known, a distance between the autonomous driving apparatus 100 and the external object may be identified through the sensing value of the sensor 120, and because the direction to which the autonomous driving apparatus 100 is facing the external object is also identifiable based on the extrinsic parameter and the intrinsic parameter of the sensor 120, coordinate values of the autonomous driving apparatus 100 in the world coordinate system may be calculated through computation based on the sensor parameter based on the coordinate values of the external object.

The processor 140 may store observation information, in other words, the first observation information obtained through the method as described above in the memory 130.

In addition, the processor 140 may receive, through the communication part 110, observation information of the external autonomous driving apparatus, in other words, the second observation information from the external autonomous driving apparatus that is present in the space in the memory 130. The second observation information of the external autonomous driving apparatus may be observation information obtained by the external autonomous driving apparatus through the sensor using the method as described above.

Specifically, the first observation information may include position information of the autonomous driving apparatus 100, position information of an object that is fixed in the space observed by the autonomous driving apparatus 100, position information of an external autonomous driving apparatus observed by the autonomous driving apparatus 100, and the like. The second observation information may include position information of the external autonomous driving apparatus, position information of an object that is fixed in the space observed by the external autonomous driving apparatus, position information of the autonomous driving apparatus 100 observed by the external autonomous driving apparatus, and the like.

In addition, the processor 140 may obtain driving history information of the external autonomous driving apparatus from the external autonomous driving apparatus through the communication part 110. Here, the driving history information may include various information associated with driving of the external autonomous driving apparatus such as, for example, and without limitation, a driving distance of the external autonomous driving apparatus, a driving time, a number of collisions with an obstacle, an intensity of collision with an obstacle, history of a parameter of a sensor mounted to the external autonomous driving apparatus having been calibrated, and the like. Here, the obstacle may include all objects that interfere with the driving of the autonomous driving apparatus such as, for example, and without limitation, walls, persons, another autonomous driving apparatus, and the like.

In addition, the processor 140 may add weight values to the first observation information based on the driving history information of the autonomous driving apparatus 100, and add weight values to the second observation information obtained from the external autonomous driving apparatus based on the driving history information of the external autonomous driving apparatus. Referring to FIG. 1 as an example, the processor 140 may obtain, through the communication part 110, observation information A1 and driving history information A2 from an external autonomous driving apparatus 200-1, and obtain observation information B1 and driving history information B2 from an external autonomous driving apparatus 200-2.

Conventionally, as the driving time becomes longer, there is a high likelihood of a state of the sensor of the autonomous driving apparatus becoming different from an initial setting state. Accordingly, the processor 140 may compare the driving times from among the driving history information, and add a greater weight value to the observation information of an apparatus with a short driving period than the observation information of an apparatus with a long driving time.

For example, if the driving time from among the driving history information of the autonomous driving apparatus 100 is 10 days, the driving time from among the driving history information A2 is 10 days, and the driving time from among the driving history information B2 is 40 days, the processor 140 may add the greater weight value to the observation information of the autonomous driving apparatus 100 and the observation information A1 than observation information B1. The weight values may be values added to the observation information, and may be values that indicate how much of an importance the relevant observation information has in terms of performing a calibration operation of the sensor parameter. The weight values may be expressed as percentage units, or expressed as decimal units. For example, with respect to the observation information of the autonomous driving apparatus 100 and the observation information A1, weight values of 44.5% or 0.445 may be added respectively, and with respect to the observation information B1, weight values of 11% or 0.11 may be added. In the example above, an example of the weight values also being set to about 4-times in size considering that the driving time is 4-times has been described, but the difference in driving times and the weight values do not necessarily have to be proportionate, and may be set to various ratios.

In addition, in the description above, although it has been described that weight values can be added to the observation information of each external autonomous driving apparatus based on the driving time of each external autonomous driving apparatus, the driving time of each external autonomous driving apparatus is merely one example of operation history information of the external autonomous driving apparatus, and weight values may be added based on driving history information such as a number of times the external autonomous driving apparatus collided with an obstacle present in the space, and an intensity of collision with the obstacle, and weight values may also be added using all information such as the driving time of the external autonomous driving apparatus, the number of times the external autonomous driving apparatus collided with an obstacle present in the space, and the intensity of collision with the obstacle. The processor 140 may add a lower weight value if the number of collisions is greater or if the intensity of collision is stronger.

The processor 140 may arithmetically estimate the intensity of collision taking into consideration speed and movement direction of the autonomous driving apparatus, speed and movement direction of the external object, and the like at the time of collision with the external object, directly sense the intensity of collision based on a sensing value of a pressure sensor, or estimate the intensity of collision based on a position change of the autonomous driving apparatus 100 before and after the collision.

The processor 140 may calibrate the sensor parameter based on the first observation information and the second observation information added with weight values by the above-described weight value adding method. As described above, because the processor 140 is capable of identifying accurate position information so long as a sensor parameter value corresponding to a state of the sensor 120 such as the position, the direction, and the like of the current sensor 120 is accurately identified, an operation for calibrating the sensor parameter may be performed. The processor 140 may obtain information with a higher reliability through the above-described weight value adding method and calibrate the sensor parameter based on the high reliable information. The calibration method of the sensor parameter will be described in detail in the following description.

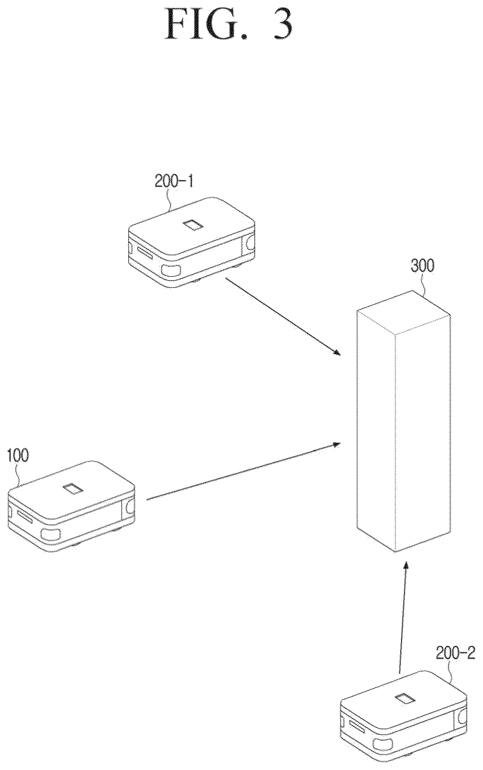

FIG. 3 is a diagram illustrating an operation of an autonomous driving apparatus according to one or more embodiments of the disclosure.

Referring to FIG. 3, if the autonomous driving apparatus 100 and the external autonomous driving apparatuses 200-1 and 200-2 are observing the same landmark 300, the autonomous driving apparatus 100 may share the observation information with the external autonomous driving apparatuses 200-1 and 200-2.

The autonomous driving apparatus 100 may obtain observation information about the landmark 300 based on the sensing value and the sensor parameter of the sensor 120, and the external autonomous driving apparatuses 200-1 and 200-2 may also obtain observation information about the landmark 300 through the sensors mounted to each of the respective external autonomous driving apparatuses.

At this time, if the autonomous driving apparatus 100 and the external autonomous driving apparatuses 200-1 and 200-2 are present together within a certain range from the landmark 300 or if the autonomous driving apparatus 100 and the external autonomous driving apparatuses 200-1 and 200-2 are facing one another or if the external autonomous driving apparatuses 200-1 and 200-2 are present within a certain distance range from the autonomous driving apparatus 100, the autonomous driving apparatus 100 and the external autonomous driving apparatuses 200-1 and 200-2 may share their respective observation information through the communication part 110.

The processor 140 may generate observation information that the landmark 300 is present at (10, 0). In addition, a first external autonomous driving apparatus 200-1 may generate observation information that the landmark 300 is present at (10, 4) through the mounted sensor, and a second external autonomous driving apparatus 200-2 may generate observation information that the landmark 300 is present at (8, 3). The processor 140 may generate coordinate values of the landmark 300 based on the observation information (10, 0) of the autonomous driving apparatus 100, the observation information (10, 4) of the first external autonomous driving apparatus 200-1 received through the communication part 110, and the observation information (8, 3) of the second external autonomous driving apparatus 200-2. An example of a process for generating the coordinate values of the landmark 300 is as described below.

First, the processor 140 may add weight values by analyzing driving history information of the first external autonomous driving apparatus 200-1 with driving history information of the second external autonomous driving apparatus 200-2, and driving history information of the autonomous driving apparatus 100. For example, the driving history of the first external autonomous driving apparatus 200-1 may include that the number of collisions with the obstacle is 1 time and that the driving time is 2 days, the driving history of the second external autonomous driving apparatus 200-2 may include that the number of collisions with the obstacle is 10 times and that the driving time is 4 days, and the driving history of the autonomous driving apparatus 100 may include that the number of collisions with the obstacle is 15 times and that the driving time is 10 days. The processor 140 may add a weight value of 70% to the observation information of the first external autonomous driving apparatus 200-1 by determining the information as having the highest reliability due to the first external autonomous driving apparatus having the smallest number of collisions and the driving time also being the shortest, add a weight value of 20% to the observation information of the second external autonomous driving apparatus 200-2 thereafter, and add only a weight value of 10% to the observation information of the autonomous driving apparatus 100 determined as information with the lowest reliability. The processor 140 may simply sum the observation information added with the weight values and identify that the position of the landmark 300 is present at (9.6, 3.4).

The processor 140 may compare a result (9.6, 3.4, 0.2) of having applied weight values to the observation information about the landmark 300 with its observation information (10, 0, 0), and calculate an offset value. The processor 140 may calibrate an existing sensor parameter for an observation result to be compensated by the calculated offset value.

In the description above, the position of the landmark 300 has been calculated through the method of simply summing by multiplying the above-mentioned weight values to the coordinate values of the landmark observed by each of the autonomous driving apparatuses, but this is merely one example, and the coordinates of the landmark may be calculated through various computation methods such as calculating the position of the landmark through a computation process that takes into consideration a likelihood of the landmark being present at a specific position by considering Gaussian distribution.

In the description above, the method by which three autonomous driving apparatuses that observed the landmark 300 calculate the coordinates of the landmark by sharing information of having observed the landmark 300 has been described, but this is merely one example, and even if three or more autonomous driving apparatuses observed the same landmark 300, the coordinates of the landmark 300 may be calculated by sharing the observation information of one another. In addition, even after the the coordinates of the landmark 300 has been calculated once, the coordinates of the landmark 300 may be calculated again every time the observation information is shared with the other external autonomous driving apparatuses, and through the above, the sensor parameter may be re-calibrated.

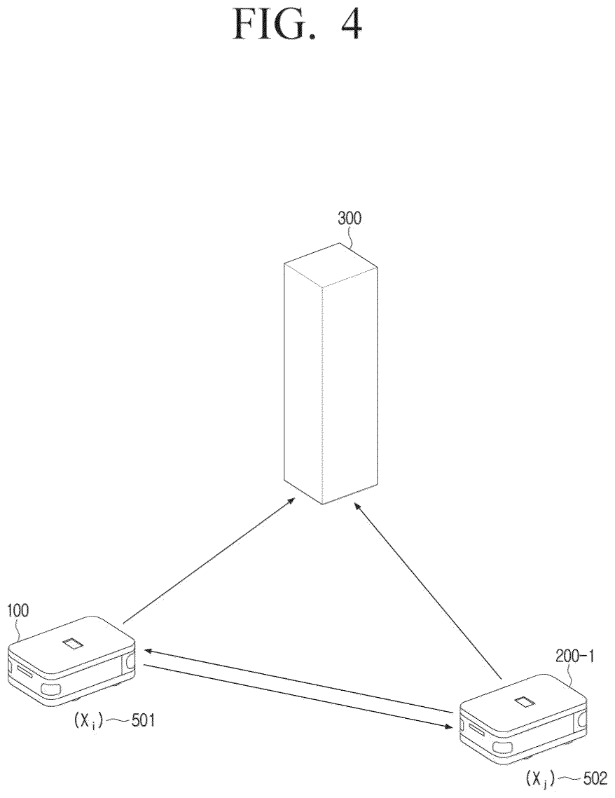

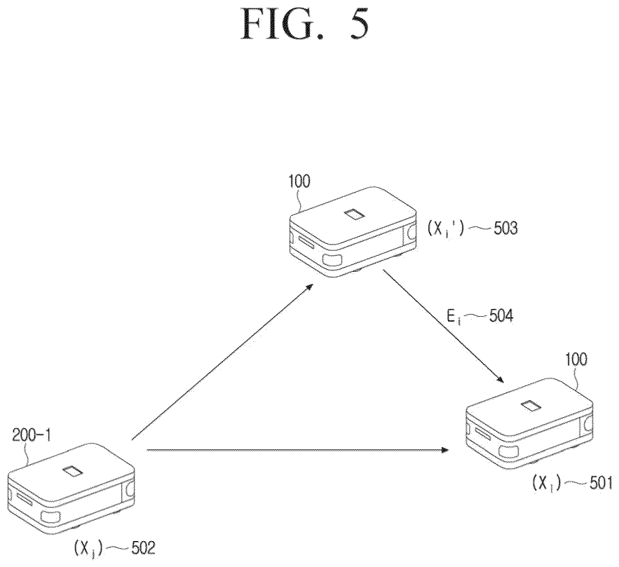

The processor 140 may not only calculate the coordinate values of the landmark 300 generated through the above-described weight value adding method and perform calibration of the sensor parameter based on the calculated coordinate values of the landmark 300, but also generate position information of the autonomous driving apparatus 100 based on the landmark 300. The processor 140 may share the generated position information with another autonomous driving apparatus and calibrate the sensor parameter through the shared observation information, and the description of the above will be described in detail in the following descriptions of FIG. 4 and FIG. 5.

FIG. 4 is a diagram illustrating a position information generating method of an autonomous driving apparatus according to one or more embodiments of the disclosure.

Referring to FIG. 4, the autonomous driving apparatus 100 and the external autonomous driving apparatus 200-1 may generate its own position information 501 and 502 based on the landmark 300.

The autonomous driving apparatus 100 may use the coordinate values of the landmark 300 to identify its own position. For example, if the coordinate values of the landmark 300 is calculated with the method described in FIG. 3, the processor 140 may identify a distance and direction of the autonomous driving apparatus 100 from the landmark based on the sensor 120 and the sensor parameter and calculate that a position of the autonomous driving apparatus 100 is (Xi)(501). The external autonomous driving apparatus 200-1 may also calculate that its position is (Xj)(502) from the same method described above. At this time, if the external autonomous driving apparatus 200-1 is present within a certain range from the autonomous driving apparatus 100 or if the external autonomous driving apparatus 200-1 is facing the autonomous driving apparatus 100, the two apparatuses may observe each other and share observation information.

If the external autonomous driving apparatus 200-1 observed the autonomous driving apparatus 100 from a position of (Xj)(502), the position of the autonomous driving apparatus 100 observed by the external autonomous driving apparatus 200-1 may be different from the position (Xi)(501) of the autonomous driving apparatus 100 calculated by the processor 140 based on the sensing value and sensor parameter of the sensor 120 based on the landmark. If the processor 140 may use, based on position information of the autonomous driving apparatus 100 observed by the external autonomous driving apparatus 200-1 received from the external autonomous driving apparatus 200-1 through the communication part 110 and position information of the autonomous driving apparatus 100 calculated by the processor 140 being different, the received position information in the calibration operation of the sensor parameter. The operation for calibrating the sensor parameter based on the observation information received from the external autonomous driving apparatus 200-1 will be described in detail in the following description of FIG. 5.

FIG. 4 shows only one external autonomous driving apparatus 200-1, but this is merely one example, and the processor 140 may receive a plurality of position information from a plurality of external autonomous driving apparatuses 200-1 and compare the position information of the autonomous driving apparatus 100 calculated by the processor 140 itself like the above-described method with the plurality of position information.

FIG. 5 is a diagram illustrating a sensor parameter calibrating method of an autonomous driving apparatus according to one or more embodiments of the disclosure.

Referring to FIG. 5, the external autonomous driving apparatus 200-1 present at position (Xj)(502) may observe the autonomous driving apparatus 100 and the processor 140 may receive information having observed the autonomous driving apparatus 100 from the external autonomous driving apparatus 200-1 through the communication part 110.

While the processor estimates that the autonomous driving apparatus 100 itself is present at the position of (Xi)(501), the external autonomous driving apparatus 200-1 may observe that the autonomous driving apparatus 100 is present at a position of (Xi′)(503). The position information estimated by the autonomous driving apparatus 100 and the position information having observed the autonomous driving apparatus 100 by the external autonomous driving apparatus 200-1 may not be a match, and an error generated between the two information when the above is not a match may be defined as Ei (504).

If the position information (Xi′)(503) of the autonomous driving apparatus 100 received from the external autonomous driving apparatus 200-1 is accurate, the processor 140 may perform a calibration operation of the sensor parameter through a method of incrementally changing the sensor parameter value and identifying the sensor parameter value that changes the above error Ei (504) to 0. However, the position information (Xi′)(503) of the autonomous driving apparatus 100 received from the external autonomous driving apparatus 200-1 may not be accurate, and unless the user checks whether the information is accurate or not directly, the autonomous driving apparatus 100 is not capable of finding out on its own. Accordingly, the processor may not calibrate the sensor parameter based only on the observation information received from one external autonomous driving apparatus 200-1, and perform the calibration operation of the sensor parameter by storing position information received from the plurality of external autonomous driving apparatuses in the memory 130 and adding weight values to each of the position information received from the plurality of external autonomous driving apparatuses only when position information sufficient enough to perform the calibration operation of the sensor parameter is stored.

For example, the autonomous driving apparatus 100 may receive position information from three external autonomous driving apparatuses consecutively. At this time, because the processor 140 is not able to directly identify whether position information received from any of the external autonomous driving apparatus from among the three external autonomous driving apparatuses is accurate information, importance is added to the observation information (e.g., position information) received from each of the external autonomous driving apparatuses by comparing the driving history information of each of the plurality of external autonomous driving apparatuses and adding weight values thereto.

Here, the importance may be a measure for determining how much of an influence will each of the observation information received from each of the plurality of autonomous driving apparatuses have when performing the calibration operation of the sensor parameter. For example, if the observation information provided with a weight value of 100% is received in the autonomous driving apparatus 100, the processor 140 may calculate the offset value by comparing only the observation information added with the weight value of 100% with its own observation information without utilizing other observation information, and calibrate the sensor parameter for the observation result to be compensated by the calculated offset value.

For example, assuming that the number of collisions by the first external autonomous driving apparatus is one time, the second external autonomous driving apparatus is two times, and a third external autonomous driving apparatus is 7 times, the processor 140 may add a weight value of 55% to the observation information received from the first external autonomous driving apparatus, add a weight value of 35% to the observation information received from the second external autonomous driving apparatus, and add a weight value of 10% to the observation information received from the third external autonomous driving apparatus.

The processor 140 may place the greatest importance on minimizing an error (E1) generated by comparing position information (X1′) received from the first external autonomous driving apparatus with position information (X1) of the autonomous driving apparatus 100 estimated by the processor 140 according to a size of the weight value added respectively thereto, and place the least importance on minimizing an error (E3) generated by comparing position information (X3') received from the third external autonomous driving apparatus with position information (X3) of the autonomous driving apparatus 100 estimated by the processor 140.

Like the above-described method, the processor 140 may repeatedly perform operations that change the sensor parameter value in order to minimize each given error according to each importance, and if a sensor parameter value capable of minimizing the error is found, the calibration operation of the sensor parameter may be performed by storing the found sensor parameter value as the calibrated sensor parameter value.

The calibration operation of the sensor parameter as described above may be performed by various algorithms that minimize errors taking into consideration the given observation information and importance of information such as a weighted least square of finding a specific parameter value for minimizing a target function obtained by adding all of the values having multiplied respective weight values to squared values of each of the errors.

Meanwhile, the observation information may be set to be shared only when the autonomous driving apparatus 100 encounters an external autonomous driving apparatus, and the observation information may be set to be shared only when an external autonomous driving apparatus is present within a certain range (e.g., 1 m) from the autonomous driving apparatus 100. For example, if the observation information is set to be shared every time an external autonomous driving apparatus approaches within 1 m from the autonomous driving apparatus 100, every time the distance between the autonomous driving apparatus 100 and an external autonomous driving apparatus becomes less than 1 m, observation information may be received from the external autonomous driving apparatus.

In the description above, although only the example of the autonomous driving apparatus 100 encountering the external autonomous driving apparatus or being present together within a certain range has been described, if autonomous driving apparatuses are present that observed the same external object by transmitting information having observed the external object to an external server every certain period (e.g., 1 hour), the autonomous driving apparatus 100 may also receive observation information through various methods such as setting the external server to transmit the observation information to the relevant autonomous driving apparatus.

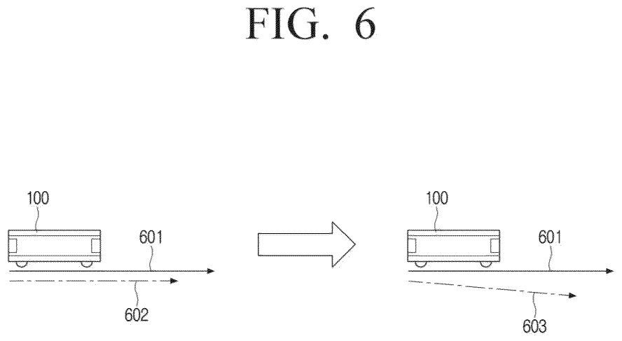

FIG. 6 is a diagram illustrating an operation of an autonomous driving apparatus according to one or more embodiments of the disclosure.

Referring to FIG. 6, an actual driving direction 601 of the autonomous driving apparatus 100 and driving directions 602 and 603 recognized by the processor 140 may be a match or may be different. For example, if the autonomous driving apparatus 100 is in a state directly after the sensor parameter is accurately calibrated, the actual driving direction 601 and the driving direction 602 recognized by the processor 140 may be a match. However, while the autonomous driving apparatus 100 is driving in the space and impacts with an obstacle or is transporting a heavy object, the position or direction of the sensor 120 may be different from the existing position or direction due to external force being applied to the autonomous driving apparatus 100. In this case, a driving direction 603 recognized by the processor 140 based on the sensing value and sensor parameter of the sensor 120 may be different from the actual driving direction 601. Accordingly, if the position and direction of the sensor becomes misaligned, the observation information may not be accurate.

Accordingly, if the autonomous driving apparatus 100 obtains observation information from an external autonomous driving apparatus that is misaligned in terms of position and direction of the sensor, weight values of the observation information obtained therefrom may be set small due to the observation information not being accurate, and conversely, because observation information obtained from an external autonomous driving apparatus in which the sensor parameter is accurately calibrated includes accurate information, weight values of the observation information obtained therefrom may be set high. The weight values described may be added based on the driving history information of each external autonomous driving apparatus that provided the observation information.

For example, if the number of collisions with an obstacle present in the space by the external autonomous driving apparatus is many, because there is a high likelihood of the position or direction of the sensor of the external autonomous driving apparatus being misaligned due to external force as a result of a collision, a low weight value may be added with respect to the observation information obtained from the external autonomous driving apparatus with a high number of collisions. Specifically, if the number of collisions with an obstacle by the first external autonomous driving apparatus is 20 times, the number of collisions with an obstacle by the second external autonomous driving apparatus is 30 times, and the number of collisions with an obstacle by the third external autonomous driving apparatus is 50 times, the processor 140 may add a weight value of 50% to the observation information obtained from the first external autonomous driving apparatus, add a weight value of 30% to the observation information obtained from the second external autonomous driving apparatus, and add a weight value of 20% to the observation information obtained from the third external autonomous driving apparatus.

In another example, if an intensity of collision with an obstacle present in the space by the external autonomous driving apparatus is great, because there is a high likelihood of the position or direction of the sensor of the external autonomous driving apparatus being misaligned due to the great impact, a low weight value may be applied with respect to the observation information obtained from an external autonomous driving apparatus with a high intensity of collision. At this time, as described above, the processor 140 may arithmetically estimate an intensity of collision taking into consideration speed and movement direction of the autonomous driving apparatus, speed and movement direction of an external object, and the like at the time of collision with the external object, directly sense the intensity of collision based on the sensing value of the pressure sensor, or estimate the intensity of collision based on a change in position of the autonomous driving apparatus 100 before and after the collision.

Specifically, if an accumulated intensity of collision is 100 Ns due to the first external autonomous driving apparatus colliding with an obstacle while driving in the space, if an accumulated intensity of collision by the second external autonomous driving apparatus is 200 Ns, and if an accumulated intensity of collision by the third external autonomous driving apparatus is 300 Ns, the processor 140 may add a weight value of 60% to the observation information obtained from the first external autonomous driving apparatus, add a weight value of 30% to the observation information obtained from second external autonomous driving apparatus, and add a weight value of 10% to the observation information obtained from the third external autonomous driving apparatus.

In still another example, the processor 140 may compare times that the external autonomous driving apparatuses drove in the space, determine that there is a high likelihood of the direction or position of the sensor being misaligned by driving operations of various types as the time driven in the space is longer, add a low weight value to observation information obtained from an external autonomous driving apparatus with a long driving time, and add the greater weight value to observation information obtained from a relevant external autonomous driving apparatus so long as it is the external autonomous driving apparatus with a short driving time.

In still another example, the processor 140 may add weight values based on a history of a parameter of the sensor mounted to the external autonomous driving apparatus being calibrated. If the sensor parameter of the external autonomous driving apparatus has been recently calibrated, accurate position information may be generated based on the sensing value, whereas, in the case of an external autonomous driving apparatus in which much time has passed since the sensor parameter was calibrated, the position information generated based on the sensing value may not be accurate. Accordingly, the processor 140 may compare a difference between the current time and time at which the sensor parameter of each external autonomous driving apparatus was calibrated, and perform calibration by adding a small weight value to the observation information obtained from an external autonomous driving apparatus with a great difference, and adding a large weight value to the observation information obtained from a relevant external autonomous driving apparatus the smaller the difference thereof is.

In the description above, the method for applying weight values based on one information from among the driving history information of the external autonomous driving apparatus such as the number of collisions with an obstacle present in the space by the external autonomous driving apparatus, the intensity of collision, the driving time in the space by the external autonomous driving apparatus, and the history of having calibrated the parameter of the sensor that is mounted to the external autonomous driving apparatus has been described, but this is merely one example, and weight values may be added to the observation information obtained from the external autonomous driving apparatus by various methods such as adding weight values taking into consideration all of the number of collisions with an obstacle, the intensity of collision, the driving time in the space by the external autonomous driving apparatus, the history of calibration of a parameter of the sensor mounted to the external autonomous driving apparatus or adding weight values by combining two or three pieces of information from among the information above.

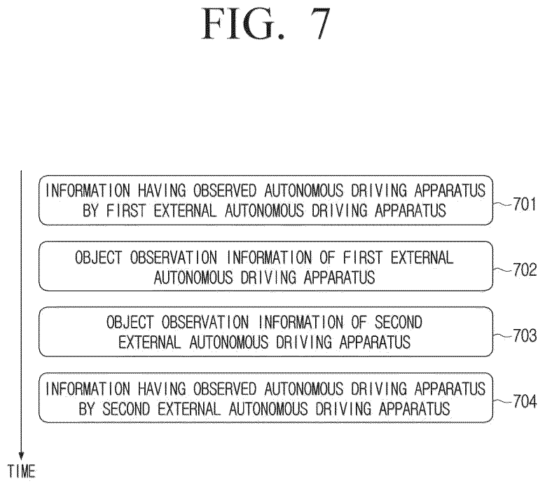

The processor 140 may add weight values according to an order of time to the observation information stored in the memory 130. The above will be described in detail in the description of FIG. 7.

FIG. 7 is a diagram illustrating a weight value adding method of an autonomous driving apparatus according to one or more embodiments of the disclosure.

Referring to FIG. 7, the memory 130 may store observation information 701, 702, 703, and 704 obtained from an external autonomous driving apparatus by arranging according to a time sequence by which the information is generated.

The processor 140 may add weight values with respect to the observation information based on a generation time of the observation information that are arranged and stored according to the time sequence in the memory 130. If observation information is accumulated for a certain time in the memory 130, because of the high likelihood of the position, the direction, and the like of the sensor becoming gradually misaligned as time passes, the processor 140 may arrange the observation information stored in the memory 130 in a time sequence, add a lowest weight value with respect to the observation information that is most recently observed and generated, and add a greater weight value to observation information for which more time has elapsed. In order to distinguish the weight values added according to the time sequence as in the method described above with the weight values added based on the above-described driving history information, the above will be referred to using the term ‘time series weight value’ in the following description.

For example, the autonomous driving apparatus 100 may share, after first sharing observation information with the first external autonomous driving apparatus 200-1, the observation information with the second external autonomous driving apparatus 200-2. The autonomous driving apparatus 100 may receive information 701 of having observed the autonomous driving apparatus 100 by the first external autonomous driving apparatus 200-1 from the first external autonomous driving apparatus 200-1, and obtain information 702 of having observed an object present in the space from the first external autonomous driving apparatus 200-1. Then, the autonomous driving apparatus 100 may obtain information 703 of having observed an object present in the space from the second external autonomous driving apparatus 200-2, and receive information 704 of having observed the autonomous driving apparatus 100 by the second external autonomous driving apparatus 200-2.

The information above 701, 702, 703, and 704 may be stored in the memory arranged by time, and the processor 140 may add time series weight value to each information. The processor 140 may add the greatest time series weight value with respect to observation information 701 with the biggest difference between the time at which the information is collected and the current time, while adding the smallest time series weight value with respect to observation information 704 with the smallest difference. For example, a time series weight value of 40% may be added with respect to the information 701 of having observed the first external autonomous driving apparatus, a time series weight value of 25% may be added with respect to the object observation information 702 of the first external autonomous driving apparatus, a time series weight value of 20% may be added with respect to the object observation information 703 of the second external autonomous driving apparatus, and a time series weight value of 15% may be added with respect to the information 704 of having observed the second external autonomous driving apparatus, and the importance that affect the operation for calibrating the sensor parameter of each observation information may be set differently.

The operation for adding time series weight value according to the time sequence of the above-described observation information may be performed after the weight value adding operation according to the driving history information described in the description portion of FIG. 3 to FIG. 6 is carried out, and may be performed first without the weight value adding operation according to the driving history information being carried out.

In the description above, an example was provided assuming that the observation information were all generated at different times, but the same time series weight value may be applied with respect to observation information generated at the same time, and the time series weight value with respect to the observation information may be added through various methods according to an algorithm applied to the autonomous driving apparatus 100.

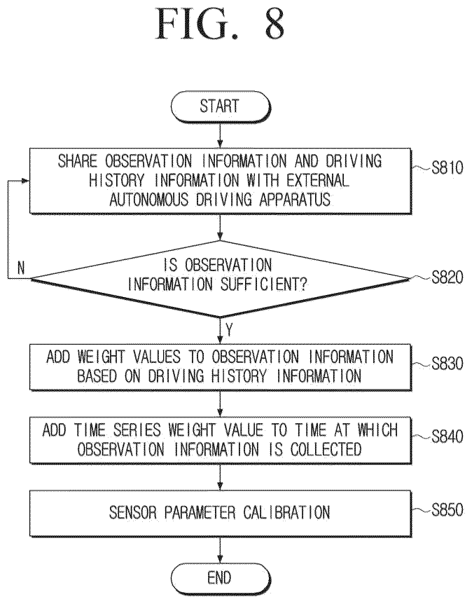

FIG. 8 is a flowchart illustrating a sensor parameter calibrating method of an autonomous driving apparatus according to one or more embodiments of the disclosure.

Referring to FIG. 8, the autonomous driving apparatus may share the observation information and the driving history information with the external autonomous driving apparatus that is present within a certain range from the autonomous driving apparatus (S810).

Here, the observation information may include the position information of the external autonomous driving apparatus observed through the sensor by the autonomous driving apparatus, the position information of the object present in the space, the position information of the autonomous driving apparatus observed by the external autonomous driving apparatus through the sensor mounted to the external autonomous driving apparatus, and the position information of the object present in the space.

In addition, the driving history information may include the number of collisions with the obstacle present in the space by the external autonomous driving apparatus, the intensity of collision with the obstacle present in the space by the external autonomous driving apparatus, the driving time in the space by the external autonomous driving apparatus, and time information on the sensor parameter of the sensor that is mounted to the external autonomous driving apparatus that is most recently calibrated.

Then, the autonomous driving apparatus may identify whether the observation information received from the external autonomous driving apparatus is sufficient enough to perform the calibration operation of the sensor parameter (S820).

If the received observation information is not sufficient, the autonomous driving apparatus receive and store observation information from the external autonomous driving apparatus every time it encounters another external autonomous driving apparatus or is positioned within a certain distance range, or every time the same landmark is observed while driving in the space.

If the received observation information is sufficient, the autonomous driving apparatus may add weight values with respect to the observation information received based on the received driving history information of the external autonomous driving apparatus (S830).

According to an embodiment, the autonomous driving apparatus may compare the number of collisions with an obstacle by each of the at least one external autonomous driving apparatus and add the smallest weight value with respect to the observation information received from the external autonomous driving apparatus with the most number of collisions with an obstacle from among the at least one external autonomous driving apparatus, and add a greater weight value with respect to the observation information received from a relevant external autonomous driving apparatus the smaller the number of collisions with an obstacle the external autonomous driving apparatus has from among the at least one external autonomous driving apparatus.

According to still another embodiment, the autonomous driving apparatus may compare the intensities of collision with an obstacle present in the space by each of the at least one external autonomous driving apparatus and add the smallest weight value with respect to the observation information received from the external autonomous driving apparatus with the greatest intensity of collision with an obstacle from among the external autonomous driving apparatus, and add a greater weight value with respect to the observation information received from a relevant external autonomous driving apparatus the smaller the intensity of collision with the obstacle the external autonomous driving apparatus has from among the at least one external autonomous driving apparatus.

According to still another embodiment, the autonomous driving apparatus may compare the driving times by each of the at least one external autonomous driving apparatus in the space and add the smallest weight value with respect to the observation information received from the external autonomous driving apparatus with the longest driving time from among the at least one external autonomous driving apparatus, and add the greater weight value with respect to the observation information received from a relevant external autonomous driving apparatus the shorter the driving time the external autonomous driving apparatus has from among the at least one external autonomous driving apparatus.

According to still another embodiment, the autonomous driving apparatus may identify, based on sensor parameter calibrating history information of the sensor mounted to each of the at least one external autonomous driving apparatus, a difference between the times at which the parameters of the sensors mounted to each of the external autonomous driving apparatuses were recently calibrated with the current time and add the smallest weight value to the observation information received from the external autonomous driving apparatus with the greatest difference from among the at least one external autonomous driving apparatus, and add a greater weight value with respect to the observation information received from the relevant external autonomous driving apparatus from among the at least one external autonomous driving apparatus the smaller the difference is.

Then, the autonomous driving apparatus may arrange the observation information by the time sequence in which the observation information is collected and add the smallest weight value with respect to the observation information that was most recently collected, and add a greater weight value with respect to the relevant observation information the more time has passed since the observation information was collected (S840).

Then, the autonomous driving apparatus may calibrate the sensor parameter of the autonomous driving apparatus based on the observation information added with the weight values (S850).

According to an embodiment, an autonomous driving apparatus includes: a communication part; a sensor for performing sensing based on at least one sensor parameter; memory storing instructions; and at least one processor, wherein the instructions, when executed by the at least one processor, cause the autonomous driving apparatus to: store, in the memory, first observation information obtained by identifying objects present in a space in which the autonomous driving apparatus is positioned in the memory based on a sensing value of the sensor; obtain, through the communication part, second observation information obtained from at least one external autonomous driving apparatus and driving history information of the at least one external autonomous driving apparatus from among objects present in the space, and store the second observation information and the driving history information in the memory; add, based on driving history information of the autonomous driving apparatus and the driving history information of the at least one external autonomous driving apparatus, weight values to each of the first observation information and the second observation information stored in the memory; and calibrate the at least one sensor parameter by comparing first and second observation information added with the weight values.

According to an embodiment, a calibration method of an autonomous driving apparatus includes: storing first observation information obtained by identifying objects present in a space in which the autonomous driving apparatus is positioned based on a sensing value of a sensor; obtaining second observation information obtained from at least one external autonomous driving apparatus and driving history information of the at least one external autonomous driving apparatus from among objects present in the space, and storing the second observation information and the driving history information; and adding, based on driving history information of the autonomous driving apparatus the and the driving history information of the at least one external autonomous driving apparatus, weight values to each of the stored first observation information and the second observation information; and calibrating at least one sensor parameter of the sensor by comparing first and second observation information added with the weight values.

According to an embodiment, a non-transitory computer-readable recording medium storing computer instructions for an autonomous driving apparatus to perform an operation when executed by a processor of the autonomous driving apparatus, the operation including: storing first observation information obtained by identifying objects present in a space in which the autonomous driving apparatus is positioned based on a sensing value of a sensor; receiving and storing second observation information from at least one external autonomous driving apparatus and driving history information of the at least one external autonomous driving apparatus from among objects present in the space; and adding, based on driving history information of the autonomous driving apparatus and the driving history information of the at least one external autonomous driving apparatus, weight values to each of the stored first observation information and the second observation information, and calibrating at least one sensor parameter of the sensor.

In the above, various embodiments have been described individually or in combination, but each of the embodiments may not be implemented alone necessarily. In other words, the various embodiments described above may be combined as a whole or partially with at least one of the other embodiments and implemented together in the one autonomous driving apparatus.

Meanwhile, methods according to the various embodiments of the disclosure described above may be implemented in an application form installable in an electronic apparatus of the related art.

In addition, the methods according to the various embodiments of the disclosure described above may be implemented with only a software upgrade, or a hardware upgrade for the electronic apparatus of the related art.

In addition, the various embodiments of the disclosure described above may be performed through an embedded server provided in the autonomous driving apparatus, or at least one external server.

Meanwhile, according to an embodiment of the disclosure, the various embodiments described above may be implemented with software including instructions stored in a machine-readable storage media (e.g., computer). The machine may call the stored instructions from the storage media, and as an apparatus operable according to the called instructions, may include the autonomous driving apparatus according to the above-mentioned embodiments. Based on a command being executed by the processor, the processor may directly or using other elements under the control of the processor perform a function relevant to the command. The command may include a code generated by a compiler or executed by an interpreter. The machine-readable storage media may be provided in a form of a non-transitory storage medium. Herein, ‘non-transitory’ merely means that the storage medium is tangible and does not include a signal, and the term does not differentiate data being semi-permanently stored or being temporarily stored in the storage medium.

In addition, according to an embodiment of the disclosure, a method according to the various embodiments described above may be provided included a computer program product. The computer program product may be exchanged between a seller and a purchaser as a commodity. The computer program product may be distributed in a form of a machine-readable storage medium (e.g., a compact disc read only memory (CD-ROM)), or distributed online through an application store (e.g., PLAYSTORE™). In the case of online distribution, at least a portion of the computer program product may be stored at least temporarily in the machine-readable storage medium such as a server of a manufacturer, a server of an application store, or memory of a relay server, or temporarily generated.

In addition, each of the elements (e.g., module or program) according to the various embodiments described above may be configured as a single entity or a plurality of entities, and a portion of sub-elements of the above-mentioned relevant sub-elements may be omitted, or other sub-elements may be further included in the various embodiments. Alternatively or additionally, a portion of the elements (e.g., modules or programs) may be integrated into one entity to perform the same or similar functions performed by the respective elements prior to integration. Operations performed by a module, a program, or another element, in accordance with various embodiments, may be executed sequentially, in a parallel, repetitively, or in a heuristic manner, or at least a portion of the operations may be executed in a different order, omitted or a different operation may be added.

While the disclosure has been shown and described with reference to the example embodiments, the disclosure is not limited to the embodiments specifically described and various modifications may be made therein by those skilled in the art to which this disclosure pertains without departing from the spirit and scope of the disclosure, and such modifications shall not be understood as separate from the technical concept or outlook of the present disclosure.

What is claimed is:

1. An autonomous driving apparatus, comprising:
a communication part;
a sensor for performing sensing based on at least one sensor parameter;
memory storing instructions; and
at least one processor,
wherein the instructions, when executed by the at least one processor, cause the autonomous driving apparatus to:
store, in the memory, first observation information obtained by identifying objects present in a space in which the autonomous driving apparatus is positioned in the memory based on a sensing value of the sensor;
obtain, through the communication part, second observation information obtained from at least one external autonomous driving apparatus and driving history information of the at least one external autonomous driving apparatus from among objects present in the space, and store the second observation information and the driving history information in the memory;
add, based on driving history information of the autonomous driving apparatus and the driving history information of the at least one external autonomous driving apparatus, weight values to each of the first observation information and the second observation information stored in the memory; and
calibrate the at least one sensor parameter by comparing first and second observation information added with the weight values.

2. The autonomous driving apparatus of claim 1, wherein the first observation information comprises position information of the autonomous driving apparatus estimated by the autonomous driving apparatus,
wherein the second observation information comprises the position information of the autonomous driving apparatus estimated by the at least one external autonomous driving apparatus, and
wherein the instructions, when executed by the at least one processor, cause the autonomous driving apparatus to:
add, based on the driving history information of the autonomous driving apparatus and the driving history information of the at least one external autonomous driving apparatus, the weight values to each of the position information of the autonomous driving apparatus estimated by the autonomous driving apparatus and the position information of the autonomous driving apparatus estimated by the at least one external autonomous driving apparatus; and
compare the position information added with the weight values and calibrate the at least one sensor parameter to compensate a difference thereof.

3. The autonomous driving apparatus of claim 1, wherein the driving history information of the at least one external autonomous driving apparatus comprises at least one from among a number of times the at least one external autonomous driving apparatus collided with an obstacle present in the space, an intensity with which the at least one external autonomous driving apparatus collided with the obstacle present in the space, a driving time of the at least one external autonomous driving apparatus in the space, or a time at which a sensor parameter of a sensor mounted to the at least one external autonomous driving apparatus is most recently calibrated.

4. The autonomous driving apparatus of claim 3, wherein the instructions, when executed by the at least one processor, cause the autonomous driving apparatus to:
compare a number of collisions generated by each of the autonomous driving apparatus and the at least one external autonomous driving apparatus while driving in the space with one another; and
add the weight values consecutively larger in an order from the autonomous driving apparatus with a large number of collisions to the autonomous driving apparatus with a small number of collisions.

5. The autonomous driving apparatus of claim 3, wherein the instructions, when executed by the at least one processor, cause the autonomous driving apparatus to:
compare collision intensities of each of the autonomous driving apparatus and the at least one external autonomous driving apparatus that collided while driving in the space; and
add the weight values consecutively larger in an order from the autonomous driving apparatus with a large collision intensity to the autonomous driving apparatus with a small collision intensity.

6. The autonomous driving apparatus of claim 3, wherein the instructions, when executed by the at least one processor, cause the autonomous driving apparatus to:
compare driving times of each of the autonomous driving apparatus and the at least one external autonomous driving apparatus in the space; and
add the weight values consecutively larger in an order from the autonomous driving apparatus with a long driving time to the autonomous driving apparatus with a short driving time.

7. The autonomous driving apparatus of claim 3, wherein the instructions, when executed by the at least one processor, cause the autonomous driving apparatus to:
identify a difference between a latest calibration time and a current time of each of the autonomous driving apparatus and the at least one external autonomous driving apparatus; and
add the weight values consecutively larger in an order from the autonomous driving apparatus with a greatest difference to the autonomous driving apparatus with a smallest difference.

8. The autonomous driving apparatus of claim 1, wherein the instructions, when executed by the at least one processor, cause the autonomous driving apparatus to:
identify a difference between an observation information collection time and a current time of each of the autonomous driving apparatus and the at least one external autonomous driving apparatus; and
add the weight values consecutively larger in an order from observation information with a greatest difference to observation information with a smallest difference.

9. A calibration method of an autonomous driving apparatus, the calibration method comprising:
storing first observation information obtained by identifying objects present in a space in which the autonomous driving apparatus is positioned based on a sensing value of a sensor;
obtaining second observation information obtained from at least one external autonomous driving apparatus and driving history information of the at least one external autonomous driving apparatus from among objects present in the space, and storing the second observation information and the driving history information; and
adding, based on driving history information of the autonomous driving apparatus the and the driving history information of the at least one external autonomous driving apparatus, weight values to each of the stored first observation information and the second observation information; and
calibrating at least one sensor parameter of the sensor by comparing first and second observation information added with the weight values.

10. The calibration method of claim 9, wherein the first observation information comprises position information of the autonomous driving apparatus estimated by the autonomous driving apparatus,
wherein the second observation information comprises the position information of the autonomous driving apparatus estimated by the at least one external autonomous driving apparatus, and
wherein the calibrating the at least one sensor parameter of the sensor comprises:
adding, based on the driving history information of the autonomous driving apparatus and the driving history information of the at least one external autonomous driving apparatus, the weight values to each of the position information of the autonomous driving apparatus estimated by the autonomous driving apparatus and the position information of the autonomous driving apparatus estimated by the at least one external autonomous driving apparatus; and
comparing the position information added with the weight values and calibrating the at least one sensor parameter to compensate a difference thereof.

11. The calibration method of claim 9, wherein the calibrating the at least one sensor parameter of the sensor comprises:
comparing a number of collisions generated by each of the autonomous driving apparatus and the at least one external autonomous driving apparatus while driving in the space with one another; and
adding the weight values consecutively larger in an order from the autonomous driving apparatus with a large number of collisions to the autonomous driving apparatus with a small number of collisions.

12. The calibration method of claim 9, wherein the calibrating the at least one sensor parameter of the sensor comprises:
comparing collision intensities of each of the autonomous driving apparatus and the at least one external autonomous driving apparatus that collided while driving in the space; and
adding the weight values consecutively larger in an order from the autonomous driving apparatus with a large collision intensity to the autonomous driving apparatus with a small collision intensity.

13. The calibration method of claim 9, wherein the calibrating the at least one sensor parameter of the sensor comprises:
comparing driving times of each of the autonomous driving apparatus and the at least one external autonomous driving apparatus in the space; and
adding the weight values consecutively larger in an order from the autonomous driving apparatus with a long driving time to the autonomous driving apparatus with a short driving time.

14. The calibration method of claim 9, wherein the calibrating the at least one sensor parameter of the sensor comprises:
identifying a difference between an observation information collection time and a current time of each of the autonomous driving apparatus and the at least one external autonomous driving apparatus, and adding the weight values consecutively larger in an order from observation information with a greatest difference to observation information with a smallest difference.

15. A non-transitory computer-readable recording medium storing computer instructions for an autonomous driving apparatus to perform an operation when executed by a processor of the autonomous driving apparatus, the operation comprising:
storing first observation information obtained by identifying objects present in a space in which the autonomous driving apparatus is positioned based on a sensing value of a sensor;
receiving and storing second observation information from at least one external autonomous driving apparatus and driving history information of the at least one external autonomous driving apparatus from among objects present in the space; and
adding, based on driving history information of the autonomous driving apparatus and the driving history information of the at least one external autonomous driving apparatus, weight values to each of the stored first observation information and the second observation information, and calibrating at least one sensor parameter of the sensor.
